(19) United States
(12) Patent Application Publication
(10) Pub. No.: US 2009/0290840 A1
(43) Pub. Date: Nov. 26, 2009

(54) Method and Apparatus for Guiding Optical Energy

(75) Inventor: Gennady Shvets, Austin, TX (US)

Correspondence Address: SCHWABE, WILLIAMSON & WYATT, P.C., 1420 FIFTH, SUITE 3010, SEATTLE, WA, 98101, US

(73) Assignee: The Board of Regents, The Univeristy of Texas System, Austin, TX (US)

(21) Appl. No.: 12/238,340

(22) Filed: Sep. 25, 2008

Related U.S. Application Data
(60) Provisional application No. 60/976,056, filed on Sep. 28, 2007.

(51) Int. Cl. G02B 6/44

(52) U.S. Cl. 385/101

(57) ABSTRACT

Embodiments herein provide an optical apparatus for focusing and guiding optical energy. An optical apparatus may include a dielectric fiber, a group of metallic wires embedded within the dielectric fiber, and a layer of metal covering an outer surface of the dielectric fiber. The metallic wires may be organized in a converging/diverging manner to guide optical waves. Other embodiments may be disclosed and claimed.

### CROSS REFERENCE TO RELATED APPLICATIONS

The present application claims priority to U.S. Provisional Patent Application No. 60/976,056, filed Sep. 28, 2007, entitled “Apparatus for Focusing and Guiding Optical Energy,” the entire disclosure of which is hereby incorporated by reference in its entirety.

### GOVERNMENT INTERESTS

This invention was made with Government support under Grant/Contract No. W911NF-04-01-0203, awarded by ARO MURI; Grant/Contract No. FA9550-06-1-0279, awarded by AFOSR MURI; and Grant/Contract No. HR0011-05-C-0068, awarded by DARPA. The Government has certain rights in the invention.

### BACKGROUND

Light diffraction poses a major obstacle to many applications that require a concentration of optical energy in a very small volume because light cannot be confined to dimensions much smaller than half of its wavelength. If the light diffraction limit is overcome, many applications will be benefited. Such applications may include nonlinear spectroscopy and harmonics generation, sub-wavelength optical waveguiding, nano-fabrication, etc. However, the high loss associated with surface plasmonics hampers many of the above-mentioned applications. Another hurdle is the availability of a practical imaging modality based on sub-wavelength plasmons capable of converting near-field electromagnetic (EM) perturbations into the far field for easy observation.

### BRIEF DESCRIPTION OF THE DRAWINGS

Embodiments herein will be readily understood by the following detailed description in conjunction with the accompanying drawings. Embodiments are illustrated by way of example and not by way of limitation in the figures of the accompanying drawings.

FIG. 1 illustrates an apparatus for guiding optical energy in accordance with various embodiments;

FIG. 2 illustrates an apparatus for guiding optical energy in accordance with various embodiments; and

FIGS. 3 and 4 illustrate magnification (FIG. 3) and demagnification (FIG. 4) using an apparatus in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments herein; however, the order of description should not be construed to imply that these operations are order dependent.

The description may use perspective-based descriptions such as up/down, back/front, and top/bottom. Such descriptions are merely used to facilitate the discussion and are not intended to restrict the application of the disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments herein, are synonymous.

Embodiments disclosed herein provide methods and apparatuses for guiding optical energy.

Embodiments herein provide an optical apparatus for focusing and guiding optical energy. In an embodiment, an optical apparatus may include a dielectric fiber, a group of metallic wires embedded within the dielectric fiber, and a layer of metal covering an outer surface of the dielectric fiber. In embodiments, the metallic wires may be organized in a converging/diverging manner to guide optical waves.

In an embodiment, a guiding/imaging device based on a plurality of metallic wires embedded in a metal-coated fiber may be provided. In an embodiment, a device may comprise a tapered fiber. In an embodiment, a tapered fiber may have embedded therein a plurality of wires. In an embodiment, the plurality of wires may be converging, such as toward a single point or area, and, in the opposite direction may, in an embodiment, be diverging away from a single point or area. In embodiments, wires may be straight or tapered. In an embodiment, a plurality of wires may comprise a periodic (regularly spaced) bundle of wires.

In an embodiment, there is provided a tapered multi-wire array supporting sub-wavelength (no cutoff) transverse electromagnetic (TEM) waves. In embodiments, a tapered endoscope may provide certain functions, including: (i) creating near the base (wide portion) of a tapered endoscope a magnified image of deeply sub-wavelength objects placed at the endoscope's tip, and/or (ii) creating near the tip of a tapered endoscope a reduced image of a mask/object placed at the endoscope's base. The magnification function enables the construction of, for example, a sub-wavelength sensor. The reduction function enables the construction of, for example, a sub-wavelength lithographic tool.

Embodiments also demonstrate that TEM modes of a multi-wire perfectly electrically conducting (PEC) transmission line have a low-loss low-dispersion plasmonic counterpart in the optical part of the spectrum paving the way to novel optical applications.

A device according to an embodiment may guide transverse electromagnetic (TEM) waves and focus them to spatial dimensions much smaller than the vacuum wavelength. Depending on the direction of use of a plurality of converging/diverging wires, a device in accordance with an embodiment may be used to magnify or to focus a sampled image or object.

In an embodiment, a device may be used, for example, as a multi-channel TEM endoscope. Such an endoscope may capture a detailed electromagnetic field profile created by deeply sub-wavelength features of a sample object and magnify it for observation. The resulting imaging method is superior to conventional scanning microscopy because of the parallel nature of the image acquisition by multiple metal wires. In embodiments, possible applications include terahertz and mid-infrared endoscopy with nanoscale resolution.

Also, in embodiments, an endoscope may be used for focusing radiation to sub-wavelength spots. A highly demagnified, focused image of a complex mask/object may be created at the tip (narrow end) of a tapered endoscope. In embodiments, a possible application includes magnetic recording assisted by laser heating.

Thus, in an embodiment, there is provided an optical apparatus for guiding optical energy comprising a dielectric fiber, a plurality of metallic wires embedded within the dielectric fiber, and a layer of metal covering an outer surface of the dielectric fiber. In an embodiment, the metallic wires may be organized in a converging manner.

A single metallic wire may be used as a low-loss waveguide of transverse electromagnetic (TEM)-like modes of THz and far-infrared radiation. However, there are many limitations when using only a one-wire waveguide. For example, if a wire is used as a high spatial resolution sensor, then only a single bit of information may be collected without scanning the wire. Thus, an array of closely spaced wires, which may act as a multi-channel sensor, may be utilized to collect information simultaneously from a spatially distributed object.

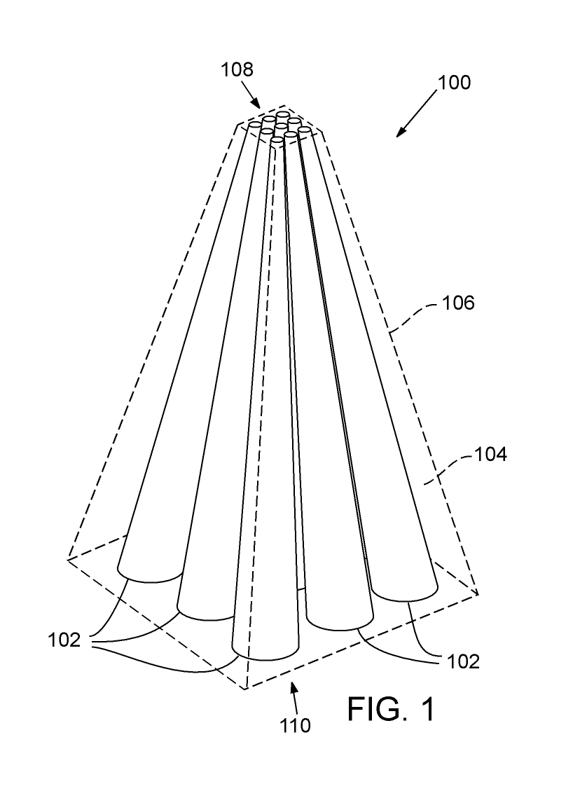

FIG. 1 depicts an apparatus for focusing and guiding optical energy, in accordance with embodiments herein. As shown, an optical apparatus 100 includes a group of metallic wires 102 embedded within a dielectric fiber 104. At least one layer of material 106 may be utilized to cover an outer surface of dielectric fiber 104 to suppress unwanted background radiation from various environmental sources. In embodiments, material 106 may be on one or more surfaces of fiber 104 and may partially or completely cover the surface(s).

In accordance with an embodiment, organized in the form of an array, metallic wires 102 are capable of guiding optical (electromagnetic) waves below a light diffraction limit. In addition, metallic wires 102 are organized in a converging/diverging manner to guide optical waves to or toward a focal point or area, and/or away from a focal point or area. The cross-section(s) of metallic wires 102 may each independently either be variable along the wires (i.e. tapered, as shown in FIG. 1) or be constant (not shown), such as substantially cylindrical.

In an embodiment, wires having relatively constant cross-sections may have a diameter of approximately 100-300 nanometers, such as approximately 200 nanometers. In an embodiment, tapered wires, such as wires 102, may have a diameter of approximately 300-500 nanometers, such as approximately 400 nanometers, at base 110 of apparatus 100, and a diameter of approximately 50-150 nanometers, such as approximately 100 nanometers, at tip 108 of apparatus 100.

In embodiments, wires 102 may be spaced apart by approximately twice their diameter, although other spacing may be utilized as desired.

In embodiments, metallic wires 102 may be made of gold, silver, copper, aluminum, gallium, or other metals or alloys. In embodiments, wires 102 may be solid or hollow. In an embodiment using hollow wires, wires 102 may have walls at least approximately 30 nm thick, such as in the range of 30 nm to 60 nm thick or larger.

Dielectric fiber 104 may be tapered (as shown) or, in an embodiment, un-tapered, and may have any of a variety of suitable cross-sections, whether uniform or non-uniform, in any of a variety of shapes, including square, rectangular, circular, oval, triangular, etc. A base 110 of an exemplary fiber 104 may be approximately 5 microns by 5 microns in size. A tip 108 of an exemplary fiber 104 may be approximately 1 micron by 1 micron in size.

In embodiments, dielectric fiber 104 may be made of at least one of silica glass, chalcogenide glass, air, or a low-loss dielectric having a positive dielectric permittivity. Thus, in an embodiment, the term fiber broadly refers to a dielectric material/substance surrounding a plurality of wires, in which the plurality of wires are configured in some manner to converge diverge. Wires may be embedded in a dielectric and/or may be coupled, organized, arranged to be converging/diverging. In addition, in an embodiment, a material, such as a metal, may surround the dielectric and the wires to contain the apparatus and to protect the wires from unwanted background radiation.

In an embodiment, material 106 may be one or more thin layers of metal to suppress unwanted background radiation. Exemplary suitable materials for material 106 may include gold, silver, copper, aluminum, tungsten, or other metals.

In an embodiment, optical apparatus 100 may provide image magnification and/or demagnification. In one embodiment utilizing image magnification, optical apparatus 100 may be a sensor for collecting electromagnetic fields from highly sub-wavelength objects in the immediate proximity of a tip 108 of optical apparatus 100 and for transforming the collected electromagnetic fields into a much larger detectable image. In an embodiment, image demagnification may be applied to surface patterning and lithography. A complex large mask/object may be placed close to the wide base 110 of optical apparatus 100 and projected/focused toward the tip 108 of optical apparatus 100 to generate a highly sub-wavelength intensity distribution in the vicinity of tip 108 of optical apparatus 100.

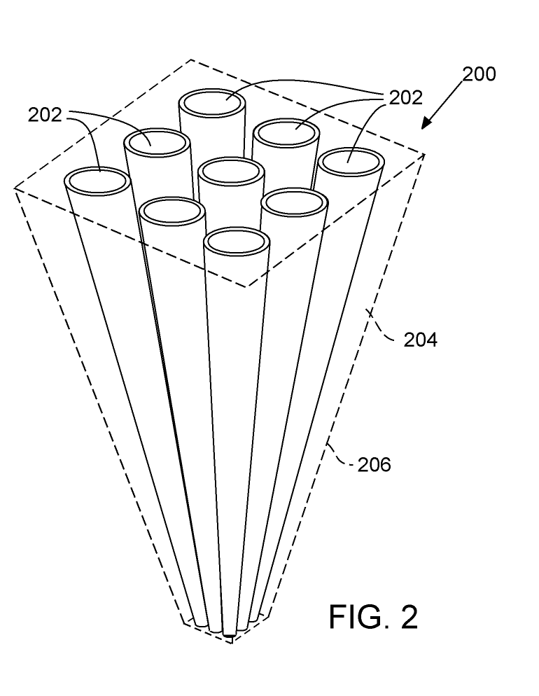

FIG. 2 illustrates an apparatus for focusing and guiding optical energy, in accordance with embodiments herein. FIG. 2 shows an optical apparatus 200 that includes a group of metallic wires 202 embedded within a dielectric fiber 204. At least one layer of material 206 may be utilized to cover an outer surface of dielectric fiber 204 to suppress unwanted background radiation from various environmental sources. As seen in FIG. 2, metallic wires 202 are hollow. Wires 202 may have walls at least approximately 30 nm thick, such as in the range of 30 nm to 60 nm thick or larger.

While FIGS. 1 and 2 illustrate a 3×3 array of wires, other numbers of wires may be utilized as desired, whether forming a uniform or non-uniform grid.

Endoscopes according to various embodiments herein may be formed using any of a variety of suitable processes, including, but not limited to, high pressure chemical vapor deposition, such as described in Sazio et al., Science, vol. 31, p. 1583 (2006).

In use, a method for demagnifying an object is provided comprising placing the object near a base of an optical apparatus, the optical apparatus comprising a dielectric fiber having a base and a tip; a plurality of metallic wires embedded within the dielectric fiber, wherein the metallic wires are organized in a converging manner to guide optical waves from the base to the tip; and at least one layer of metal covering an outer surface of the dielectric fiber; illuminating the object by a radiation source to allow waves to propagate along the fiber in a direction of convergence to form a demagnified image. In a similar fashion, a method for magnifying an object is provided comprising placing the object near a tip of an optical apparatus, the optical apparatus comprising a dielectric fiber having a base and a tip; a plurality of metallic wires embedded within the dielectric fiber, wherein the metallic wires are organized in a diverging manner to guide optical waves from the tip to the base; and at least one layer of metal covering an outer surface of the dielectric fiber; illuminating the object by a radiation source to allow waves to propagate along the fiber in a direction of divergence to form a magnified image.

In an embodiment, the term “object” is used broadly to refer to the magnified or demagnified element, regardless of size, scale, or construction.

In an embodiment, a magnification arrangement of an endoscope may be used in conventional diffractive optics to image various objects.

In an embodiment used for imaging purposes, a sub-wavelength object placed near the tip of the endoscope may be illuminated by a laser beam or other light/radiation source. The image at the base of the endoscope may be viewed through an infrared microscope, for example.

In an embodiment, a demagnification arrangement of an endoscope may be used for lithography. For lithographic purposes, a mask (e.g., a metallic mask), may be placed near the wide base and illuminated by a laser beam or other light/radiation source. The sub-wavelength image would appear in the vicinity of the tip.

In embodiments, any suitable light or radiation source may be used in conjunction with an optical apparatus such as optical, terahertz, or microwave radiation.

In an exemplary embodiment, a base of a tapered endoscope may have a 10L₀×10L₀ square cross-section (where L₀ is a scale length), with separation between the wires (at the base) being d=3L₀, and wire diameters of W=2L₀. In an embodiment, the dimensions may be proportionately reduced by a factor of 5 at the tip. Such an exemplary simulation illustrates image magnification and demagnification by a factor of 5. In an embodiment, the tapered endoscope may be terminated on both ends by a waveguide, such as a single-mode (2λ/3×2λ/3) metallic waveguide.

In embodiments, a multi-channel endoscope may have a much larger (e.g., 25×25) number of metal wires, although other numbers and sizes of arrays may be used as desired.

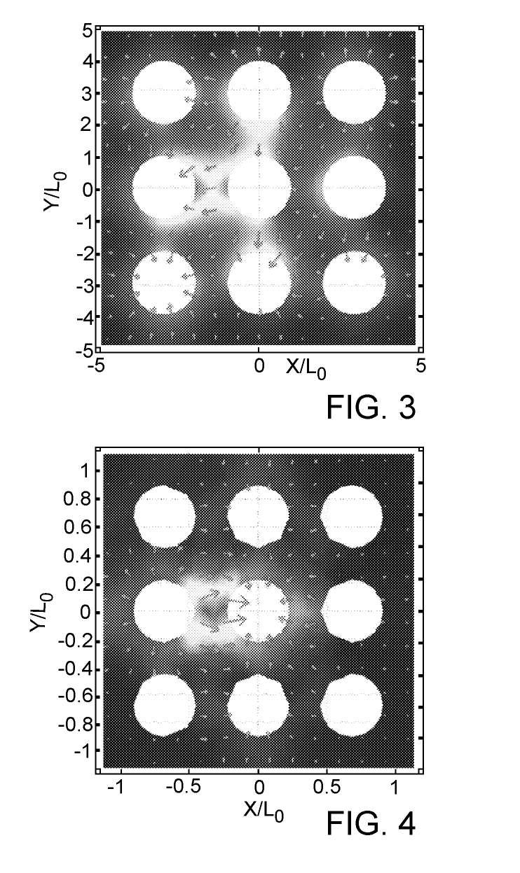

Using the exemplary arrangement for magnification, a small metallic sphere with diameter Dₛₘₐₗₗ=λ/25 may be placed at a distance Δz=0.7 Dₛₘₐₗₗ above the endoscope's tip half-way between the central wire and the next one on the left. The sphere may be illuminated from the top by a circularly polarized electromagnetic wave. An exemplary image of |\vec{E}⊥|² taken at zᵢₘ=L₀ (slightly above the endoscope's base) may be represented in FIG. 3 (arrows represent the electric field). The sphere's image (or that of any strong scatterer) magnified by a factor 5 appears as an enhanced field in the image plane. The following intensity contrasts are found: I_{scatt}/I_{wires}=3 and I_{wires}/I_{wg}=10³. Thus, in an embodiment, a sub-wavelength object placed near the tip of a tapered endoscope may be magnified by a factor 5 near the base of the endoscope.

The opposite process (de-magnification, or image focusing) may also be demonstrated using the same tapered endoscope. A metallic sphere with the diameter D_{large}=λ/5 may be placed at a distance Δz=0.7 D_{large} below the endoscope's base half-way between the central wire and the next one on the left. The image located in the plane of the tip (hot spot shown in FIG. 4) is spatially compressed by a factor 5. Despite the fact that the electromagnetic wave propagates through a very narrow waveguide, field intensity in the hot spot is about the same as that of the incident wave. Had the coupling efficiency of the incident wave into TEM waves been close to unity, one would expect an intensity increase by a factor of 25 due to the narrowing of the endoscope's area. That this is not happening in this example is attributed to the low coupling efficiency because of the sub-wavelength size of the scattering sphere. Nevertheless, this simulation illustrates that extremely sub-wavelength intensity landscapes may be created near the tip of a tapered nanowire array. The following intensity contrasts may be found: I_{scatt}/I_{wires}=15 and I_{scatt}/I_{wg}=10⁵.

The above-described numerical simulations were performed using an assumption that the wires are perfectly electrically conducting (PEC). This assumption is highly accurate in the far-infrared and THz frequency ranges. It is, however, instructive to check whether the concept of a multi-wire endoscope may also be useful for mid-infrared wavelengths. Below, it is demonstrated that electromagnetic modes of an array of plasmonic wires closely resembling TEM modes of an array of PEC wires do exist. These surface plasmon polariton (SPP) modes possess two essential properties enabling them to guide, focus, and perform local sensing in the nanoscale: (a) they are low loss, and (b) they are essentially dispersion-less in the transverse direction, i.e. ω²/c²≈ak²+β\vec{k}⊥², where β<<a. In embodiments, the TEM-like SPPs are sufficiently low-loss and dispersion-less that the performance of the un-tapered and tapered multi-wire endoscopes described herein are barely affected.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments herein be limited only by the claims and the equivalents thereof.

What is claimed is:

1. An optical apparatus for guiding optical energy, the optical apparatus comprising:
a dielectric fiber;
a plurality of metallic wires embedded within the dielectric fiber, wherein the metallic wires are organized in a converging manner to guide optical waves; and
at least one layer of metal covering an outer surface of the dielectric fiber.

2. The optical apparatus of claim 1, wherein the metallic wires comprise at least one of gold, silver, copper, aluminum or gallium.

3. The optical apparatus of claim 1, wherein the metallic wires are solid wires.

4. The optical apparatus of claim 1, wherein the metallic wires are hollow.

5. The optical apparatus of claim 4, wherein the hollow metallic wires have walls at least about 30 nm thick.

6. The optical apparatus of claim 4, wherein the hollow metallic wires have walls about 30 to 60 nm thick.

7. The optical apparatus of claim 1, wherein the metallic wires have a substantially constant cross-section.

8. The optical apparatus of claim 1, wherein the metallic wires are tapered.

9. The optical apparatus of claim 1, wherein the dielectric fiber is tapered.

10. The optical apparatus of claim 1, wherein the dielectric fiber comprises at least one of silica glass, chalcogenide glass, or air.

11. The optical apparatus of claim 1, wherein the dielectric fiber comprises a low-loss dielectric having a positive dielectric permittivity.

12. The optical apparatus of claim 1, further comprising a waveguide at one or more ends of the dielectric fiber.

13. The optical apparatus of claim 1, wherein the metallic wires are configured to guide optical waves below a light diffraction limit.

14. The optical apparatus of claim 1, wherein the at least one layer of metal comprises at least one of gold, silver, copper, aluminum, or tungsten.

15. An optical apparatus for guiding optical energy, the optical apparatus comprising:
a plurality of metallic wires configured in a converging manner to guide optical waves;
a dielectric surrounding each of the plurality of wires; and
at least one layer of metal surrounding the dielectric and the plurality of wires.

16. The optical apparatus of claim 15, wherein the dielectric comprises at least one of silica glass, chalcogenide glass, or air.

17. The optical apparatus of claim 15, wherein the dielectric comprises a low-loss dielectric having a positive dielectric permittivity.

18. A demagnification method, comprising:
placing an object near a base of an optical apparatus, wherein the optical apparatus includes:
a dielectric fiber having a base and a tip;
a plurality of metallic wires embedded within the dielectric fiber, wherein the metallic wires are organized in a converging manner to guide optical waves from the base to the tip; and
at least one layer of metal covering an outer surface of the dielectric fiber;
illuminating the object with a radiation source to allow waves to propagate along the dielectric fiber in a direction of convergence to form a demagnified image.

19. The method of claim 18, wherein the object is demagnified by a factor equal to a ratio between lateral dimensions of the base and the tip.

20. A magnification method, comprising:
placing an object near a tip of an optical apparatus, wherein the optical apparatus includes:
a dielectric fiber having a base and a tip;
a plurality of metallic wires embedded within the dielectric fiber, wherein the metallic wires are organized in a diverging manner to guide optical waves from the tip to the base; and
at least one layer of metal covering an outer surface of the dielectric fiber;
illuminating the object with a radiation source to allow waves to propagate along the dielectric fiber in a direction of divergence to form a magnified image.

21. The method of claim 20, wherein the object is magnified by a factor equal to a ratio between lateral dimensions of the base and the tip.
